(19) United States
(12) Patent Application Publication
(10) Pub. No.: US 2016/0035127 A1
(43) Pub. Date: Feb. 4, 2016

(54) THREE-DIMENSIONAL IMAGE DISPLAY SYSTEM, SERVER FOR THREE-DIMENSIONAL IMAGE DISPLAY SYSTEM, AND THREE-DIMENSIONAL IMAGE DISPLAY METHOD

(71) Applicant: Panasonic Intellectual Property Management Co., Ltd., Osaka (JP)

(72) Inventor: YUDAI ISHIBASHI, Osaka (JP)

(21) Appl. No.: 14/879,138

(22) Filed: Oct. 9, 2015

Related U.S. Application Data
(63) Continuation of application No. PCT/JP2014/001571, filed on Mar. 19, 2014.

(30) Foreign Application Priority Data
Apr. 19, 2013 (JP) 2013-088099

(51) Int. Cl. G06T 15/10; H04L 29/06; G06T 1/60

(52) U.S. Cl. CPC G06T 15/10; G06T 1/60; H04L 67/42

(57) ABSTRACT

Three-dimensional image display system includes server and client cooperating with server to display three-dimensional image. Server includes server memory storing vertex information indicating a vertex position of a polygon that forms a three-dimensional shape, valid polygon identification unit converting the vertex information into different coordinate systems, determining whether the polygon is a valid polygon for displaying based on the converted vertex information and viewpoint information transmitted from client, and generating valid vertex information indicating whether the vertex is valid for rendering the valid polygon, and server communicator transmitting valid vertex information to client. Client includes client memory storing the vertex information indicating the vertex position of the polygon that forms the three-dimensional shape, client communicator transmitting viewpoint information and receiving valid vertex information, and a polygon rendering unit reading the vertex information for only the valid vertex in valid vertex information, converting into different coordinate systems, and generating three-dimensional image.

### 1. FIELD OF THE INVENTION

The present disclosure relates to three-dimensional computer graphics techniques, and to a three-dimensional image display system and a three-dimensional image display method in which a server and a client cooperate to render a three-dimensional shaped polygon model.

### 2. DESCRIPTION OF THE RELATED ART

Three-dimensional computer graphics processing is disposing a virtual three-dimensional solid body in three-dimensional space interactively on a screen based on user's viewpoint information or the like, and generating an image to be displayed on a display.

In the three-dimensional computer graphics processing, a computational load and memory access load that occur during the processing are heavy. In order to mount the three-dimensional computer graphics processing in an information processing terminal, reducing these loads is a subject.

Patent Literature 1 discloses an example of a configuration that reduces the load of the information processing terminal. In the configuration of Patent Literature 1, a server performs three-dimensional computer graphics processing and encodes the generated image into video data. The server transmits the encoded video data via a network to a client. The client decodes the received video data and displays the decoded video data on a display. Patent Literature 1 discloses the configuration in which the information processing terminal of the client receives the image performed three-dimensional computer graphics processing, and displays the image on the display, without performing heavy-load three-dimensional computer graphics processing.

Patent Literature 2 discloses another example. In a configuration of Patent Literature 2, in displaying a map three-dimensionally, a terminal device gets only polygon data required for display from a server and controls the communication data volume.

### CITATION LIST

### Patent Literatures

PTL 1: Japanese Translation of PCT Publication No. 2012-521268

PTL 2: Unexamined Japanese Patent Publication No. 2007-255989

### SUMMARY OF THE INVENTION

The present disclosure provides a three-dimensional image display system which achieves both reduction in a client load and reduction in a network load.

A three-dimensional image display system and three-dimensional image display method according to the present disclosure are a three-dimensional image display system including a server and a client cooperating with the server to display a three-dimensional image display. The server includes a server memory configured to store vertex information indicating a vertex position of a polygon that forms a three-dimensional shape, a valid polygon identification unit configured to convert the vertex information stored in the server memory into a different coordinate system, to decide whether the polygon is a valid polygon for displaying based on the converted vertex information and viewpoint information transmitted from the client, and to generate valid vertex information indicating whether the vertex is valid for rendering the valid polygon, and a server communicator configured to transmit the valid vertex information to the client. The client includes a client memory configured to store the vertex information indicating the vertex position of the polygon that forms the three-dimensional shape, a client communicator configured to transmit the viewpoint information to the server and to receive the valid vertex information from the server, and a polygon rendering unit configured to read the vertex information stored in the client memory for only the valid vertex in the valid vertex information, to convert the vertex information into a different coordinate system, and to generate a three-dimensional image.

This allows the three-dimensional image display system and three-dimensional image display method according to the present disclosure to achieve both reduction in a client load and reduction in a network load.

### BRIEF DESCRIPTION OF DRAWINGS

FIG. 1 is a block diagram illustrating an example of a configuration of a three-dimensional image display system according to an exemplary embodiment.

FIG. 2 is a diagram illustrating an example of data stored in a server memory according to the exemplary embodiment.

FIG. 3 is a diagram illustrating an example of data stored in a client memory according to the exemplary embodiment.

FIG. 4 is a flowchart illustrating an example of an operation of a server according to the exemplary embodiment.

FIG. 5 is a diagram illustrating decision whether rendering of a polygon is valid.

FIG. 6A is a diagram illustrating an example in which a polygon model is formed in a polygon strip format.

FIG. 6B is a diagram illustrating correspondence between the polygon model of FIG. 6A and valid vertex information.

FIG. 6C is a diagram illustrating an example of the generated valid vertex information.

FIG. 6D is a diagram illustrating another example of the generated valid vertex information.

FIG. 6E is a diagram illustrating still another example of the generated valid vertex information.

FIG. 7 is a flowchart illustrating an example of an operation of a client according to the exemplary embodiment.

### DETAILED DESCRIPTION OF THE PREFERRED EMBODIMENT

An exemplary embodiment will be described in detail below with reference to the drawings as needed. However, a description that is more detailed than necessary may be omitted. For example, a detailed description of an already well-known item and a repeated description of substantially identical components may be omitted. This is for avoiding the following description from becoming unnecessarily redundant and for making the description easier for a person skilled in the art to understand.

It is to be noted that the accompanying drawings and the following description are provided in order for a person skilled in the art to fully understand the present disclosure, and are not intended to limit the subject described in the appended claims.

### Exemplary Embodiment

In recent years, a data size of an image generated by three-dimensional computer graphics processing increases as a resolution of a display of an information processing terminal becomes higher. As a result, a size of video data resulting from encoding of the generated image also increases. As in a configuration of Patent Literature 1, an image on which a server performs three-dimensional computer graphics processing is transmitted to a client which is the information processing terminal and a heavy load occurs on a network. Therefore, displaying the image on the display in the information processing terminal is delayed. Moreover, excessive compression of video data for reducing the network load causes degradation of image quality of a display image on the display of the information processing terminal. As in a configuration of Patent Literature 2, the server transmits only a polygon data required for display to the client in order to reduce communication data volume and data volume of each polygon required for display is large. Thus the network load becomes large.

As described above, when three-dimensional computer graphics processing in the conventional information processing terminal is performed on the server connected via the network, there is a subject that the load on the network increases even though the load on the information processing terminal is reduced.

Therefore, an object of the present disclosure is to provide a three-dimensional image display system that allows both reduction in the load on the information processing terminal and reduction in the network load.

In the three-dimensional computer graphics processing implemented with the three-dimensional image display system according to the present exemplary embodiment, a polygon model which represents a three-dimensional object by combination of polygonal shapes and a virtual camera which serves as a viewpoint are disposed in three-dimensional space. And the polygon model captured by the virtual camera is displayed on a screen and an image is generated by the polygon model.

In the three-dimensional computer graphics processing, three-dimensional space in which the polygon model and the virtual camera are disposed is referred to as a scene.

The three-dimensional image display system according to the present exemplary embodiment forms one scene by rendering the disposed polygon model on a display screen. In the present exemplary embodiment, a scene which is a rendering object is referred to as an object scene, and a polygon model which is a rendering object, forming the object scene is referred to as an object polygon.

### 1. CONFIGURATION

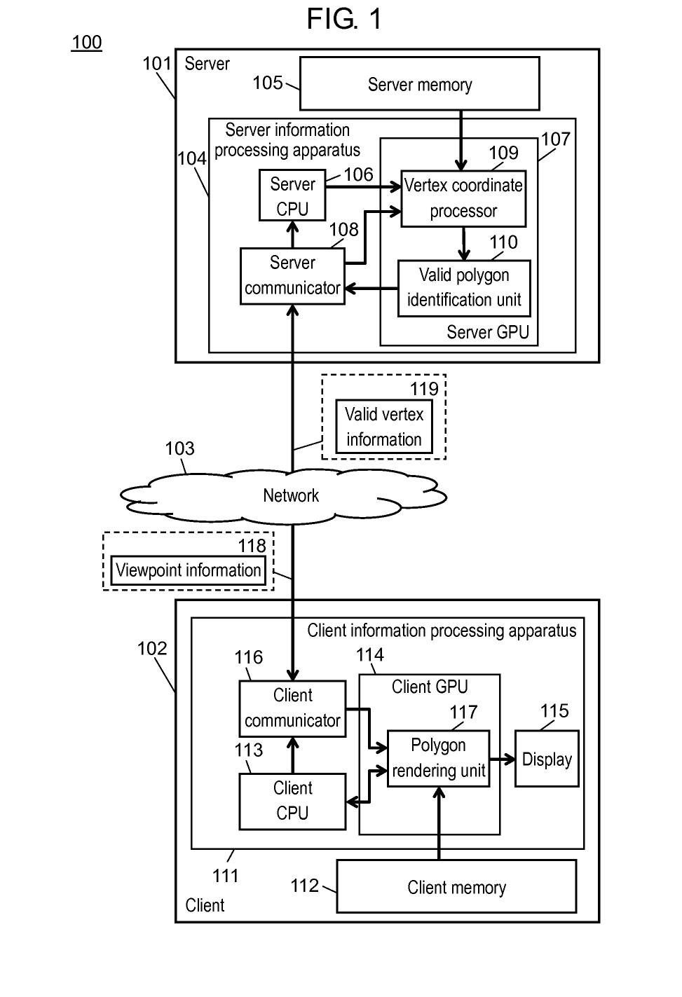

FIG. 1 is a block diagram illustrating an example of a configuration of the three-dimensional image display system according to the exemplary embodiment. As illustrated in FIG. 1, in three-dimensional image display system 100, server 101 is connected to client 102 via network 103.

Server 101 includes server information processing apparatus 104 and server memory 105.

Server information processing apparatus 104 includes server Central Processing Unit (CPU) 106, server Graphics Processing Unit (GPU) 107, and server communicator 108.

Server GPU 107 includes vertex coordinate processor 109 and valid polygon identification unit 110.

Client 102 includes client information processing apparatus 111 and client memory 112.

Client information processing apparatus 111 includes client CPU 113, client GPU 114, display 115, and client communicator 116.

Client GPU 114 includes polygon rendering unit 117.

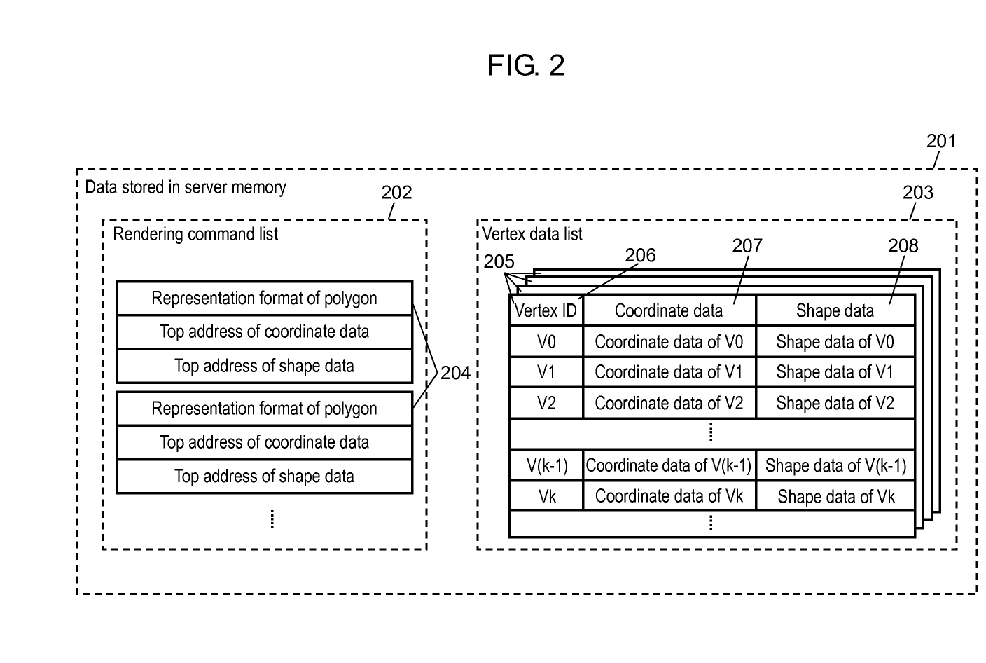

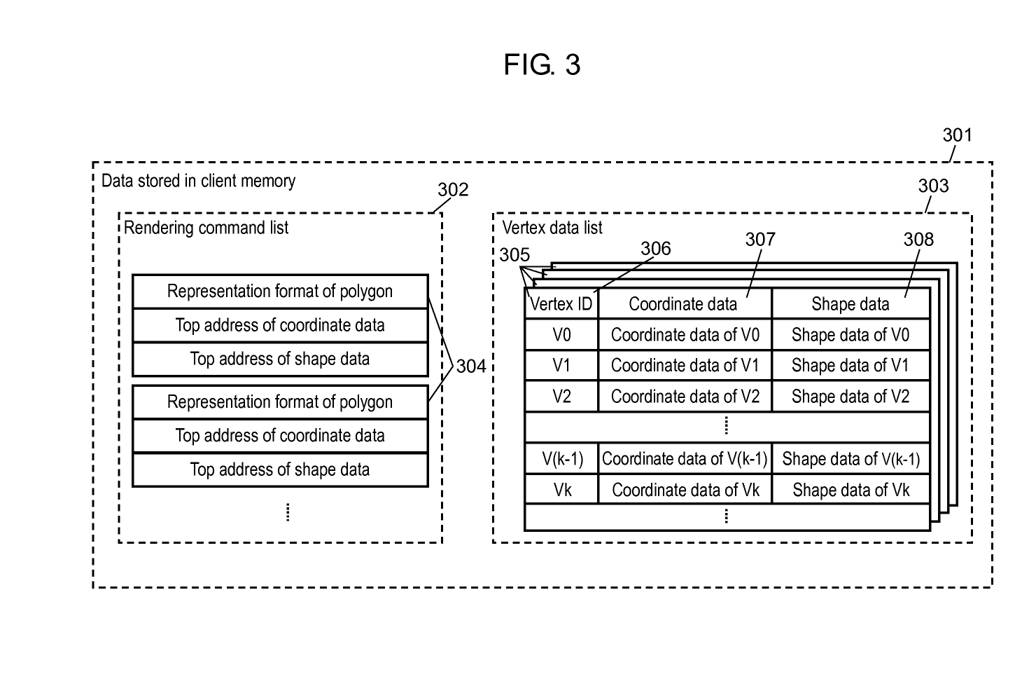

FIG. 2 is a diagram illustrating an example of data stored in server memory 105 according to the exemplary embodiment. FIG. 3 is a diagram illustrating an example of data stored in client memory 112 according to the exemplary embodiment. Server memory 105 and client memory 112 each previously store data required for displaying a three-dimensional image.

Server memory 105 stores data 201 including rendering command list 202 and vertex data list 203.

Rendering command list 202 includes rendering command 204 which indicates information regarding a polygon rendering command. As illustrated in FIG. 2, rendering command 204 includes a representation format of a polygon which is a rendering object and top addresses of various data for vertex data 205 described later. As the representation format of a polygon, there are a polygon strip format, a polygon fan format, and a polygon mesh format.

Vertex data list 203 is a list of vertex data 205 representing information on vertexes which form the polygon of the polygon model. Vertex data 205 includes vertex ID 206, coordinate data 207, and shape data 208. Vertex ID 206 represents a number of the vertexes of the polygon model. As illustrated in FIG. 2, Vertex IDs 206 are V0, V1, V2, . . . , V (k−1), and Vk (k is an integer equal to or greater than 1). Coordinate data 207 represents a position of each of the vertexes of the polygon model. Shape data 208 represents information other than the coordinate data of each vertex of the polygon model, for example, normal line data, color data, and texture coordinate data of each vertex.

Client memory 112 stores data 301 identical to data 201 with a configuration identical to a configuration of data 201 stored in server memory 105. In other words, rendering command list 302 corresponds to rendering command list 202, vertex data list 303 corresponds to vertex data list 203, rendering command 304 corresponds to rendering command 204, vertex data 305 corresponds to vertex data 205, vertex IDs 306 correspond to vertex IDs 206, coordinate data 307 corresponds to coordinate data 207, and shape data 308 corresponds to shape data 208.

Client CPU 113 conveys a rendering start instruction to client GPU 114 and server 101. The rendering start instruction to server 101 is sent from client communicator 116 via network 103 to server communicator 108 and further to server CPU 106. The rendering start instruction is, for example, an instruction to specify a number of a scene on which starts displaying a three-dimensional image. Client GPU 114 receives the rendering start instruction.

Client GPU 114 which receives the rendering start instruction sends first viewpoint information 118 at the time of rendering start to client CPU 113. Viewpoint information 118 is a predetermined viewpoint such as an origin. Client CPU 113 sends viewpoint information 118 from client communicator 116 to server communicator 108 via network 103 and further to server GPU 107.

Server CPU 106 receives the rendering start instruction and conveys the rendering start instruction to server GPU 107. In server GPU 107 which receives the rendering start instruction, vertex coordinate processor 109 loads rendering command 204 of the object scene which is a rendering object from among rendering command list 202 in server memory 105, and vertex data 205 which is a rendering object from among vertex data list 203.

In server GPU 107, vertex coordinate processor 109 calculates world coordinates which are coordinates of the vertex of the object polygon viewed from a viewpoint of viewpoint information 118 received from client CPU 113, in three-dimensional space, and screen coordinates which are coordinates of the vertex of the object polygon on the screen, based on viewpoint information 118 and coordinate data 207 indicating a position of the vertex of the polygon in vertex data 205 loaded from server memory 105.

Next, valid polygon identification unit 110 decides whether rendering of the object polygon is valid based on the world coordinates and the screen coordinates calculated by vertex coordinate processor 109, and outputs valid polygon rendering information. And valid polygon identification unit 110 generates the valid vertex information 119 of the vertexes which forms the object polygon from the valid polygon rendering information of the object polygon.

Server communicator 108 transmits valid vertex information 119 generated by valid polygon identification unit 110 from server communicator 108 to client communicator 116 via network 103.

Client communicator 116 receives valid vertex information 119 received from server communicator 108, and sends valid vertex information 119 to polygon rendering unit 117. Polygon rendering unit 117 receives the rendering start instruction and valid vertex information 119 and loads rendering command 304 of the object scene which is a rendering object from among rendering command list 302 stored in client memory 112, and only vertex data 305 which is decided to be valid from received valid vertex information 119, out of object vertex data 305 from among vertex data list 303 of the object scene. Then, polygon rendering unit 117 calculates the world coordinates which are the coordinates viewed from the viewpoint, in the three-dimensional space, and the screen coordinates which are the coordinates on a screen, based on first viewpoint information 118 at the time of rendering start and coordinate data 307 included in loaded vertex data 305. Polygon rendering unit 117 generates the image on the screen by calculating a color value of each pixel of the polygon based on calculated coordinate values and shape data 308 included in loaded vertex data 305.

The image generated by polygon rendering unit 117 is displayed on display 115.

### 2. OPERATION

An operation of server 101 and an operation of client 102 of the three-dimensional image display system according to the exemplary embodiment will be described below with reference to the drawings.

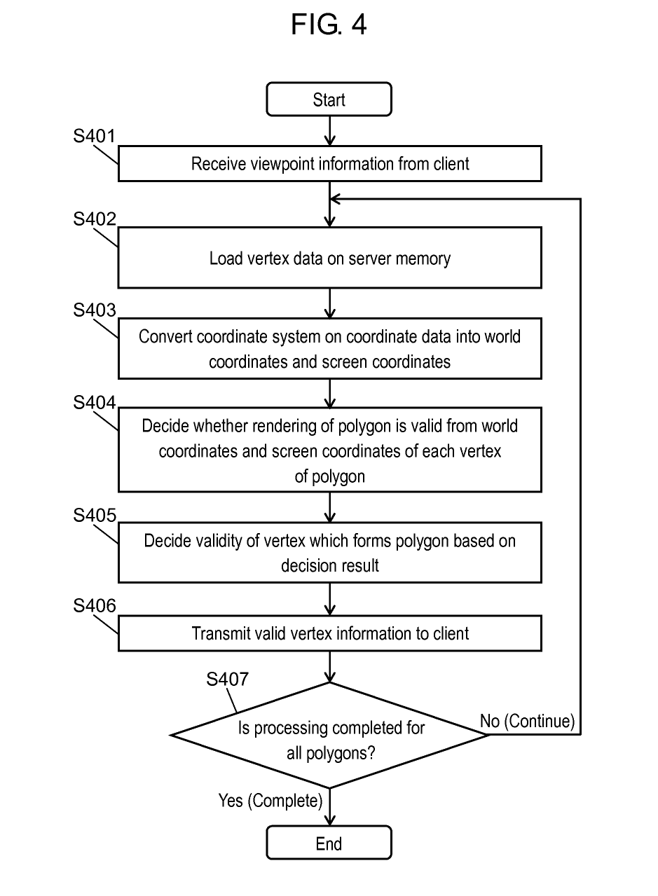

FIG. 4 is a flowchart illustrating an example of an operation of server 101 according to the exemplary embodiment. In a description of the flowchart of FIG. 4, it is assumed that the rendering start instruction has previously been provided.

### (Step S401)

Vertex coordinate processor 109 receives, through server communicator 108, viewpoint information 118 transmitted from client CPU 113 via client communicator 116 and network 103.

### (Step S402)

Vertex coordinate processor 109 receives the rendering start instruction and viewpoint information 118 and loads rendering command 204 of the object scene which is a rendering object from among rendering command list 202 stored in server memory 105 and vertex data 205 which is a rendering object from among vertex data list 203 stored in server memory 105.

### (Step S403)

Next, vertex coordinate processor 109 converts coordinate data 207 of loaded vertex data 205 into world coordinates and screen coordinates.

### (Step S404)

Valid polygon identification unit 110 decides whether rendering of the object polygon is valid from the world coordinates and screen coordinates calculated for each vertex which forms the polygon, and generates a decision result as valid polygon rendering information.

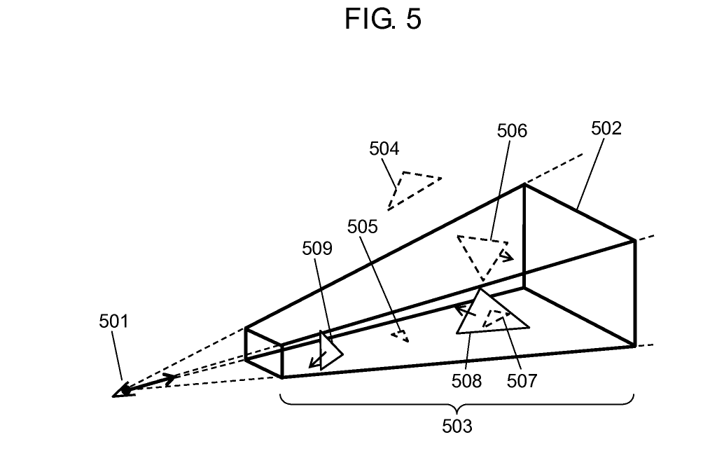

Decision whether rendering of the object polygon is valid is performed as follows, for example. FIG. 5 is a diagram illustrating decision whether rendering of the object polygon is valid. The decision whether rendering of the object polygon is valid is processing for deciding whether the polygon formed of the plurality of vertexes is used at a time of image generation. The decision whether rendering of the object polygon is valid uses coordinate data converted into screen coordinates with respect to viewpoint 501 as the origin. If the polygon can be projected on screen 502 viewed from viewpoint 501, rendering is valid. Otherwise rendering is invalid. Specifically, four types of decision are performed for the decision whether rendering of the object polygon is valid.

In first decision, it is decided whether the object polygon is inside a hexahedron indicating visible space 503. If coordinates of all the vertexes among the vertexes which form the object polygon are outside visible space 503, rendering of the object polygon is invalid. For example, polygon 504 which are outside visible space 503 is invalid.

In second decision, it is decided whether a displayed portion of the object polygon is less than 1 pixel when the object polygon is projected on screen 502. For example, polygon 505, is a small object polygon which is horizontally disposed with respect to viewpoint 501 is invalid.

In third decision, it is decided whether a polygon surface of the object polygon which is on visible space 503 is a front surface, viewed from viewpoint 501. A plane normal vector is obtained from coordinates of the vertex which forms the object polygon. The front surface and back surface of the polygon is decided by checking a sign of an inner product of the plane normal vector and a viewpoint direction vector. When the surface of the object polygon viewed from viewpoint 501 is the back surface, rendering of the polygon is invalid. For example, the surface of polygon 506 viewed from viewpoint 501 is the back surface and rendering of the polygon is invalid.

In fourth decision, it is decided, when the object polygon is projected on screen 502, whether the object polygon is disposed behind another polygon and disappears. For example, polygon 507 is disposed behind polygon 508 when projected on screen 502 and rendering is invalid.

In all of the above four types of decision, the polygon with valid rendering is decided that rendering is valid. For example, rendering of polygon 508 and rendering of polygon 509 are valid.

### (Step S405)

Furthermore, valid polygon identification unit 110 decides whether the vertex which forms the polygon is valid based on the valid polygon rendering information which indicates the decision result of whether rendering of the polygon is valid. And valid polygon identification unit 110 generates valid vertex information 119.

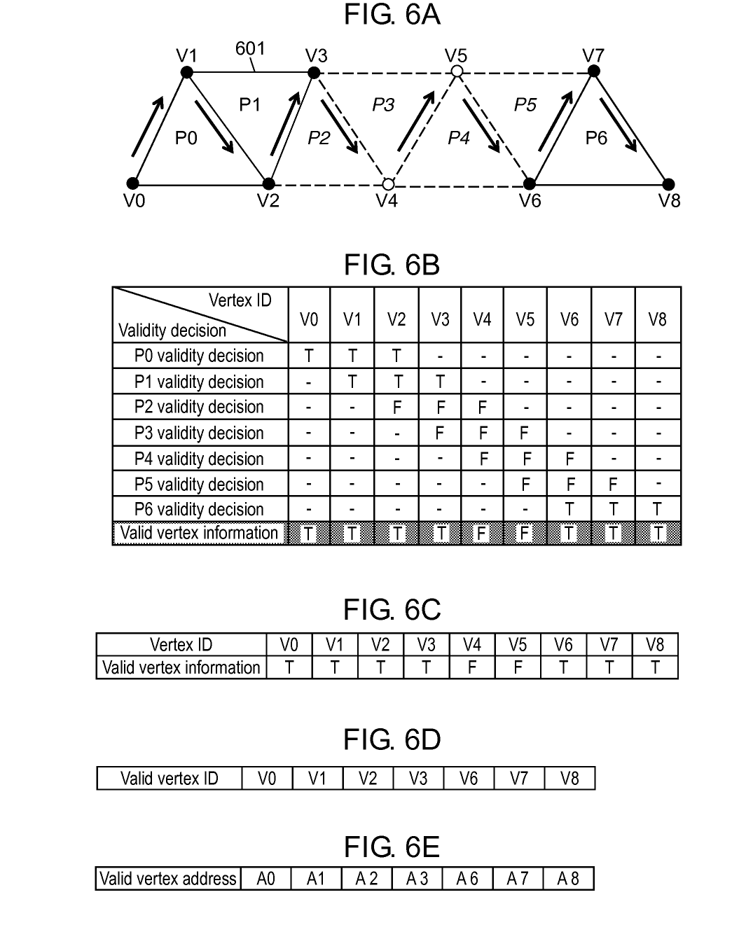

FIG. 6A is a diagram illustrating an example of a polygon model formed in a polygon strip format. FIG. 6B is a diagram illustrating correspondence between the polygon model of FIG. 6A and valid vertex information. FIG. 6C is a diagram illustrating an example of the generated valid vertex information. FIG. 6D is a diagram illustrating another example of the generated valid vertex information. FIG. 6E is a diagram illustrating still another example of the generated valid vertex information. The polygon strip format is a format which renders polygons continuously while sharing vertexes. As illustrated in FIG. 6A, a polygon Pj (j=0 to 6) of polygon strip 601 is formed of three points having vertex IDs of Vj, Vj+1, and Vj+2. In addition, the vertex IDs of polygon strip 601 are specified in order of V0→V1→V2→V3→V4→V5→V6→V7→V8. It is assumed that polygons P0, P1, and P6 are valid polygons.

Decision whether a vertex which forms a polygon is valid is made in order of V0→V1→V2→V3→V4→V5→V6→V7→V8. When decision is made whether a vertex Vi is valid, logical sum calculation of valid polygon rendering information on polygons Pi−2, Pi−1, and Pi including the vertex Vi is performed. That is, if at least one piece of the valid polygon rendering information on the object polygon is valid, the vertex Vi is decided to be valid. It is to be noted that, in this decision, valid polygon rendering information about a polygon number which does not exist is invalid.

FIG. 6B illustrates this decision. Specifically, regarding the vertex V0, the valid polygon rendering information on the polygon P0 which includes the vertex V0 indicates validity T and the vertex V0 is decided to be valid. Regarding the vertex V1, the valid polygon rendering information on both of the polygons P0 and P1 which include the vertex V1 indicates validity T, and the vertex V1 is decided to be valid. Regarding the vertex V2, the valid polygon rendering information on the polygons P0 and P1 among the polygons P0, P1, and P2 which include the vertex V2 indicates validity T, and the vertex V2 is decided to be valid. Regarding the vertex V3, the valid polygon rendering information on the polygon P1 among the polygons P1, P2, and P3 which include the vertex V3 indicates validity T, and the vertex V3 is decided to be valid. Regarding the vertex V4, the valid polygon rendering information on all the polygons among the polygons P2, P3, and P4 which include the vertex V4 indicates invalidity F, and the vertex V4 is decided to be invalid. Also regarding the vertex V5, the valid polygon rendering information on all the polygons among the polygons P3, P4, and P5 which include the vertex V5 indicates invalidity F, and the vertex V5 is decided to be invalid. Regarding the vertex V6, the valid polygon rendering information on the polygon P6 among the polygons P4, P5, and P6 which include the vertex V6 indicates validity T, and the vertex V6 is decided to be valid. Regarding the vertex V7, the valid polygon rendering information on the polygon P6 among the polygons P5 and P6 that include the vertex V7 indicates validity T, and the vertex V7 is decided to be valid. Regarding the vertex V8, the valid polygon rendering information on the polygon P6 which includes the vertex V8 indicates validity T, and the vertex V8 is decided to be valid. Valid polygon identification unit 110 generates the valid vertex information that the vertexes V0, V1, V2, V3, V6, V7, and V8 are valid, and that the vertexes V4 and V5 are invalid.

The format of the valid vertex information may be a list of the valid vertex information corresponding to the vertex IDs as in FIG. 6C, may be a list of only the vertex IDs with the valid vertex information being valid as in FIG. 6D, or may be a list of only address information of the vertex IDs with the valid vertex information being valid as in FIG. 6E.

### (Step S406)

Server communicator 108 transmits valid vertex information 119 generated by valid polygon identification unit 110 to client communicator 116. The network load can be reduced through transmission of valid vertex information 119 to client 102 as necessary minimum information.

### (Step S407)

When the processing from step S402 to step S406 is not completed for all the object polygons of the object scene, server 101 returns to step S402 and the processing for the next polygon is continued. When the processing from step S402 to step S406 is completed, the operation of server 101 ends.

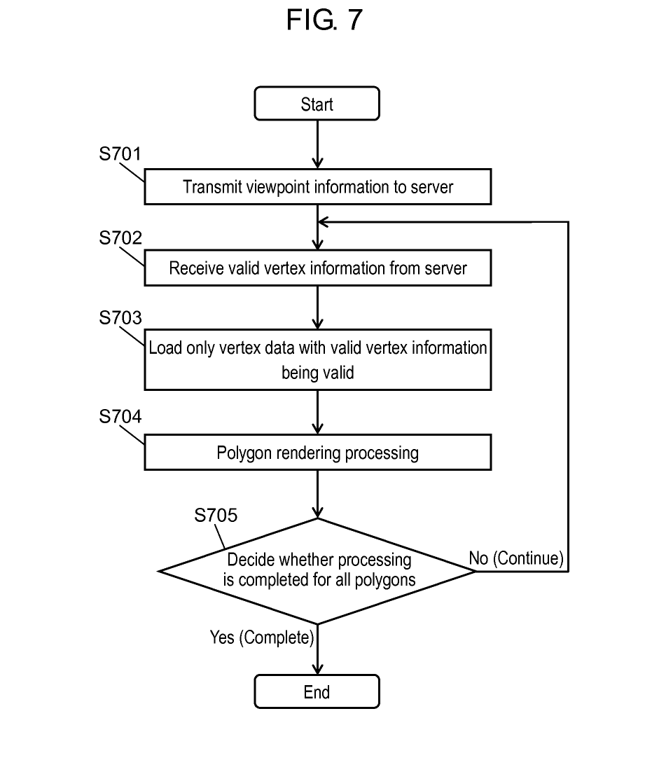

FIG. 7 is a flowchart illustrating an example of an operation of client 102 according to the exemplary embodiment. In a description of the flowchart of FIG. 7, it is assumed that the rendering start instruction has previously been provided.

### (Step S701)

Client GPU 114 that receives the rendering start instruction sends first viewpoint information 118 at the time of rendering start to client CPU 113. Viewpoint information 118 is a predetermined viewpoint such as an origin. Client CPU 113 sends viewpoint information 118 to server GPU 107 through client communicator 116 and server communicator 108. Polygon rendering unit 117 loads rendering command 304 of an object scene which is a rendering object from among rendering command list 302 in client memory 112.

### (Step S702)

Client communicator 116 receives valid vertex information 119 transmitted from server communicator 108, and sends valid vertex information 119 to polygon rendering unit 117.

### (Step S703)

Polygon rendering unit 117 checks, for each vertex ID, whether the vertex included in the object polygon is valid from the received valid vertex information 119. If the vertex is valid, polygon rendering unit 117 loads only valid vertex ID 306, valid coordinate data 307, and valid shape data 308, out of vertex data 305 which is a rendering object from among vertex data list 303 of the object scene which is a rendering object stored in client memory 112. For example, when the valid vertex information is shown in FIG. 6C, the valid vertex IDs are V0, V1, V2, V3, V6, V7, and V8, and polygon rendering unit 117 loads only coordinate data 307 and shape data 308 corresponding to these vertex IDs.

### (Step S704)

Polygon rendering unit 117 generates a screen image of the object polygon by converting loaded coordinate data 307 into world coordinates and screen coordinates, and by calculating a color value of each pixel of the polygon based on calculated coordinate values and loaded shape data 308. The image generated by polygon rendering unit 117 is displayed on display 115.

### (Step S705)

When the processing from step S702 to step S704 is completed for all the object polygons of the object scene, the operation of client 102 ends. When the processing from step S702 to step S704 is not completed for all the object polygons of the object scene, the processing from step S702 to step S704 is executed for a next polygon.

Regarding the operation of server 101 and the operation of client 102 of the three-dimensional image display system according to the present exemplary embodiment, timing to transmit viewpoint information 118 from client CPU 113 may be transmission at predetermined intervals, or may be transmission only when viewpoint information 118 changes.

It is to be noted that as the viewpoint information, in addition to the viewpoints, not only the predetermined viewpoints such as the origin, but also one or more pieces of information may be used as the viewpoint information from among a scene number of a scene the client wants to display, a visible scope of a display screen on the client, a projection parameter which indicates how to project on two-dimensional space from three-dimensional space on the display screen on the client, information such as a position/amount of movement/moving speed/moving acceleration/shape change/color change after an operation of the object which is the scene change in which the user of the client operates a menu or an object in the scene.

It is to be noted that, although a description of the operation provided on an assumption that data 201 stored in server memory 105 is identical to data 301 stored in client memory 112, data 201 does not need to be identical to data 301. Coordinate data 207 required for processing out of vertex data 205 included in vertex data list 203 of data 201 stored in server memory 105 may be identical to coordinate data 307 of vertex data 305 included in vertex data list 303 of data 301 stored in client memory 112. In addition, vertex ID 206 and coordinate data 207 out of vertex data 205 included in vertex data list 203 of data 201 stored in server memory 105 may be identical to vertex ID 306 and coordinate data 307 of vertex data 305 included in vertex data list 303 of data 301 stored in client memory 112.

It is to be noted that valid vertex information may have a format other than the examples of FIG. 6C, FIG. 6D, and FIG. 6E. For example, since the server memory and the client memory store identical vertex data and order of the vertex ID is also identical, a format of only T with the rendering validity information being valid or only F with rendering validity information being invalid may be used in order of the vertex ID, out of the format of FIG. 6C.

### 3. SUMMARY

In the three-dimensional image display system according to the present exemplary embodiment, the server specifies the vertex required for rendering of the object polygon based on the viewpoint information received from the client and the coordinate data included in the vertex data of the polygon which forms the polygon model stored in the server memory. And the server transmits, to the client, the valid vertex information which indicates the vertex of the valid polygon for rendering. Based on the received valid vertex information, the client renders the polygon by accessing only the coordinate data and shape data of necessary minimum vertex data in the client memory. This configuration makes it possible to implement generation of a three-dimensional computer graphics processing image, while reducing the load of the three-dimensional computer graphics processing of the client, also reducing the network load because video data is not transmitted on the network.

### 4. OTHER CONFIGURATIONS

Although the three-dimensional image display system according to the present disclosure has been described, the present disclosure is not limited to this example.

For example, server 101 and client 102 do not necessarily need to be in a one-to-one relationship, and a configuration of a plurality of clients corresponding to one server may be used. This configuration makes it possible to achieve both reduction in the network load and reduction in the load of three-dimensional computer graphics processing of each client 102 if three-dimensional image display system 100 includes one server 101 having strong throughput.

In addition, although four types of decision are made for the decision made by valid polygon identification unit 110 whether rendering of the object polygon is valid, part of the four types may be selected, or another decision may be made. Reduction in decision can reduce the processing load of valid polygon identification unit 110. Conversely addition of decision reduces the polygon to render, and the load of the three-dimensional computer graphics processing at client 102 can further be reduced.

The CPU and GPU of each of server information processing apparatus 104 and client information processing apparatus 111 according to the present exemplary embodiment may be individually integrated into integrated circuits, and may be integrated into one integrated circuit. In addition, part or all of each of the server information processing apparatus and client information processing apparatus may be implemented by a program on a general-purpose processor, and may be implemented by using an Field Programmable Gate Array (FPGA) which allows alteration of a hardware configuration after manufacture or a reconfigurable processor that allows reconfiguration of connections and settings of circuit cells inside an integrated circuit.

In addition, the present disclosure can be implemented as a recording medium, such as a computer-readable Compact Disc-Read Only Memory (CD-ROM) which records the above-described program, or can also be implemented as information, data, or a signal which represents the program. Then, such program, information, data, and signal may be distributed via a communication network such as the Internet.

What is claimed is:

1. A three-dimensional image display system comprising:
a server; and
a client cooperating with the server to display a three-dimensional image,
the server comprising:
a server memory configured to store vertex information indicating a vertex position of a polygon that forms a three-dimensional shape;
a valid polygon identification unit configured to convert the vertex information stored in the server memory into a different coordinate system, to decide whether the polygon is a valid polygon for displaying based on the converted vertex information and viewpoint information transmitted from the client, and to generate valid vertex information indicating whether the vertex is valid for rendering the valid polygon; and
a server communicator configured to transmit the valid vertex information to the client,
the client comprising:
a client memory configured to store the vertex information indicating the vertex position of the polygon that forms the three-dimensional shape;
a client communicator configured to transmit the viewpoint information to the server and to receive the valid vertex information from the server; and
a polygon rendering unit configured to read the vertex information stored in the client memory for only the valid vertex in the valid vertex information, to convert the vertex information into a different coordinate system, and to generate a three-dimensional image.

2. The three-dimensional image display system according to claim 1, wherein the vertex information stored in the client memory includes coordinate data indicating the vertex position and shape data indicating information other than the coordinate data.

3. A server, cooperating with a client to display a three-dimensional image, in a three-dimensional image display system,
the server comprising:
a server memory configured to store vertex information indicating a vertex position of a polygon that forms a three-dimensional shape;
a valid polygon identification unit configured to convert the vertex information stored in the server memory into a different coordinate system, to decide whether the polygon is a valid polygon for displaying based on the converted vertex information and viewpoint information transmitted from the client, and to generate valid vertex information indicating whether the vertex is valid for rendering the valid polygon; and
a server communicator configured to transmit the valid vertex information to the client.

4. A three-dimensional image display method for displaying a three-dimensional image, the method comprising:
converting vertex information indicating a vertex position of a polygon that forms a three-dimensional shape into a different coordinate system, determining whether the polygon is a valid polygon for displaying based on the converted vertex information and viewpoint information, and generating valid vertex information indicating whether the vertex is valid for rendering the valid polygon; and
transmitting the valid vertex information.
